(19) United States
(12) Patent Application Publication
(10) Pub. No.: US 2006/0019078 A1
(43) Pub. Date: Jan. 26, 2006

(54) Multi-layer fiber reinforced thermoplastic and method for making the same

(75) Inventors: Samuel J. Osten, Wexford, PA (US); Michael C. LaRocco, Sewickley, PA (US)

Correspondence Address: THE WEBB LAW FIRM, P.C., 700 KOPPERS BUILDING, 436 SEVENTH AVENUE, PITTSBURGH, PA, 15219, US

(73) Assignee: American Made LLC., Ambridge, PA (US)

(21) Appl. No.: 10/895,535

(22) Filed: Jul. 21, 2004

(51) Int. Cl. D04H 1/00; B32B 27/04; B32B 3/00

(52) U.S. Cl. 428/292.1; 428/297.4; 442/59

(57) ABSTRACT

A multi-layer fiber reinforced thermoplastic panel is fabricated using a first fiber reinforced thermoplastic sheet having thermoplastic with a first melting point, a second fiber reinforced thermoplastic sheet having thermoplastic with a second melting point, and a connecting layer therebetween. The connecting layer is made of a thermoplastic-compatible material having a third melting point which is less than the first melting point and second melting point. The connecting layer is bonded to the thermoplastic in the first sheet and the second sheet. The subject invention is also directed to a method of fabricating such a panel.

### BACKGROUND OF THE INVENTION

1. Field of the Invention

The invention relates to a panel made up of fiber reinforced thermoplastic sheets bonded together with a thermoplastic-compatible connecting layer.

2. Description of Related Art

Bonding thermoplastic materials may be accomplished using a variety of surface treatments that chemically modify the surface of the material, including chemical treatments of primers, flame treating or corona treating.

Two problems arise from using these treatments. First, the treatment uses a second processing step that requires additional equipment and cost. Second, the bond is a chemical bond that occurs only at the surface of the interface of the two materials.

The sheets may also be secured to one another with mechanical fasteners such as screws or, on the other hand, utilizing glue between the two sheets. However, in utilizing these techniques, it is difficult, if not impossible, to secure together two sheets such that there is no gap between them. Such a feature is especially important when the two fiber reinforced thermoplastic sheets are being utilized as the wall and associated scuff pad within the storage compartment of a refrigerator trailer. Under these circumstances, and with the existence of gaps, moisture will build up in gaps between the two sheets and will produce mildew and the associated undesirable odor.

A panel is needed whereby two sheets may be bonded together in a relatively simple and inexpensive process such that there are no gaps between these two sheets that would be susceptible to moisture and the formation of mildew.

### SUMMARY OF THE INVENTION

One embodiment of the subject invention is directed to a multi-layer fiber reinforced thermoplastic panel comprised of a first fiber reinforced thermoplastic sheet, wherein the thermoplastic has a first melting point. The panel is also comprised of a second fiber reinforced thermoplastic sheet, wherein the thermoplastic has a second melting point. There is a connecting layer between the first sheet and the second sheet, wherein the connecting layer is made of a thermoplastic-compatible material having a third melting point less than the first and second melting points and wherein the connecting layer is bonded to the thermoplastic in the first sheet and in the second sheet.

Another embodiment of the subject invention is directed to a method of forming a multi-layer fiber reinforced thermoplastic panel with a first fiber reinforced thermoplastic sheet bonded to a second fiber reinforced thermoplastic sheet, wherein the thermoplastic in the first sheet has a first melting point and the thermoplastic in the second sheet has a second melting point. The method comprises the steps of:
a) introducing a first connecting film upon the first sheet, wherein the first connecting film is made of a thermoplastic-compatible material having a third melting point, which is less than the first melting point, to define a first arrangement;
b) heating the first arrangement to a temperature above the first melting point to bond the first connecting film to the first sheet;
c) introducing a second connecting film upon the second sheet, wherein the second connecting film is made of a thermoplastic-compatible material having a third melting point less than the second melting point to define a second arrangement;
d) heating the second arrangement to a temperature above the second melting point to bond the second connecting film to the second sheet;
e) placing the first arrangement against the second arrangement such that the first connecting film is contacting the second connecting film to define a composite panel; and
f) heating the composite panel to a temperature above the third melting point but below the first and second melting points to bond the connecting films to one another to form a connecting layer and thereby bond the first sheet to the second sheet.

Yet another embodiment of the invention is directed to a method of making a pair of identical composite panels, wherein each composite panel has a longitudinal axis and is made of a first fiber reinforced thermoplastic sheet with a second fiber reinforced thermoplastic sheet attached thereto by a connecting film bonded to each sheet, wherein the second sheet has a width less than half that of the first sheet and wherein the second sheet is positioned at the edge of the first sheet, wherein the method comprises the steps of:
a) placing one composite panel against the other composite panel such that the second sheet of each panel contacts the first sheet of the other panel to form a symmetrical shape when viewed along the longitudinal axis;
b) compressing the first sheet and second sheet against the connecting film; and
c) heating the pair of composite panels to a temperature above the melting point of the connecting film but below the melting point of the thermoplastic in each of the first and second thermoplastic sheets, such that the connecting film of each first and second sheet in each composite panel fuse to one another thereby forming a connecting layer and bonding together the first sheet and the second sheet of each composite panel.

### BRIEF DESCRIPTION OF THE DRAWINGS

FIG. 1 is prior art and illustrates the manner by which two fiber reinforced thermoplastic sheets may be bonded to one another;

FIG. 2 illustrates a side view of the multi-layer fiber reinforced thermoplastic in accordance with the subject invention;

FIG. 3 illustrates the manner by which two fiber reinforced thermoplastic sheets may be bonded to one another in accordance with the subject invention;

FIG. 4 illustrates the two fiber reinforced thermoplastic sheets illustrated in FIG. 3 contacting one another;

FIG. 5 is a cross-sectional view along arrows 5-5 in FIG. 4;

FIG. 6 is the arrangement illustrated in FIG. 5 after heat is applied;

FIGS. 7-12 illustrate one method whereby a multi-layer fiber reinforced thermoplastic panel is fabricated;

FIG. 13 illustrates a cross-sectional view of two fiber reinforced thermoplastic panels positioned to form a symmetrical arrangement;

FIG. 14 illustrates the use of a double belt press to process the symmetrically arranged panels illustrated in FIG. 13; and

FIG. 15 illustrates a final product of two multi-layer fiber reinforced thermoplastic panels which were produced after the symmetrical arrangement illustrated in FIG. 13 was processed by the double belt press illustrated in FIG. 14.

### DETAILED DESCRIPTION OF THE INVENTION

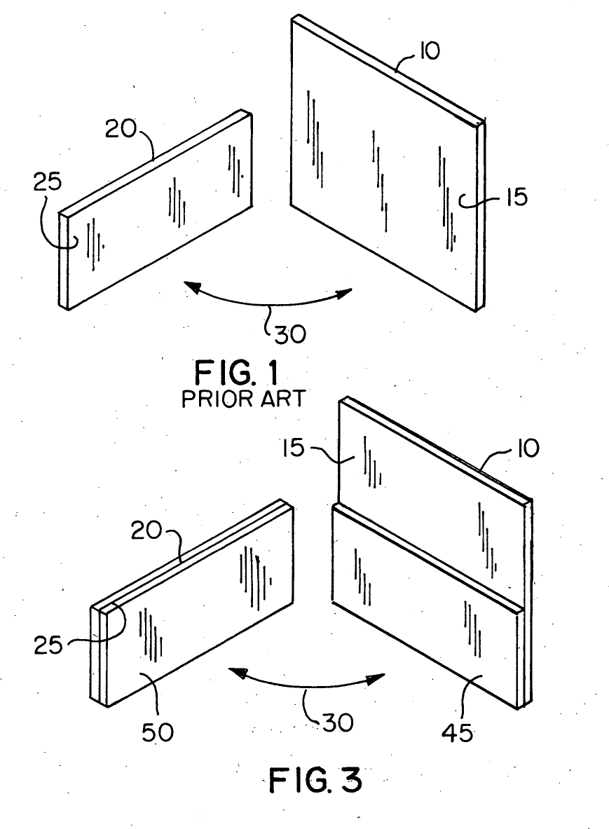

FIG. 1 illustrates a first fiber reinforced thermoplastic sheet 10 having a first face 15 and a second fiber reinforced thermoplastic sheet 20 having a first face 25 which, as indicated by arrow 30, are intended to be mated with one another.

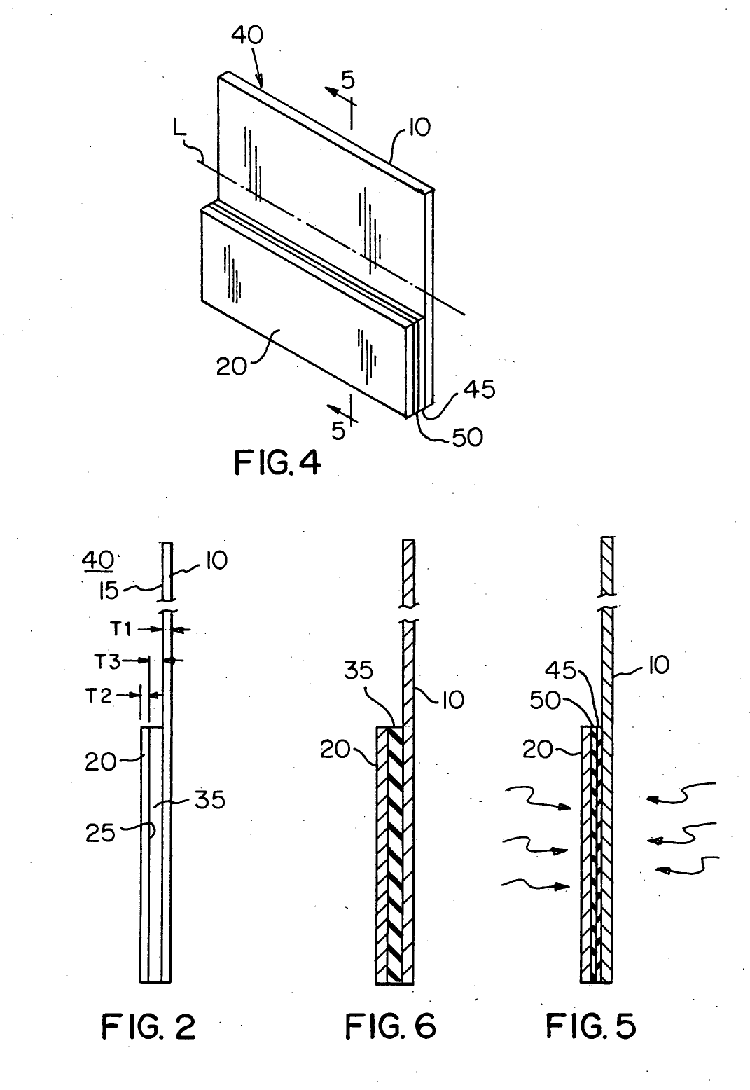

FIG. 2 illustrates a multi-layer fabric reinforced thermoplastic panel 40 comprised of a first fiber reinforced thermoplastic sheet 10 having a front face 15 and a second fiber reinforced thermoplastic sheet 20 having a first face 25. A connecting layer 35 is between the first sheet 10 and the second sheet 20. The first sheet 10 has thermoplastic therein having a melting point MP1. The second sheet 20 has thermoplastic therein having a melting point MP2. The connecting layer 35 is made of a thermoplastic-compatible material having a third melting point MP3. A thermoplastic-compatible material is a material that when heated together with a thermoplastic base will bond with the thermoplastic base. The connecting layer 35 is bonded to the thermoplastic in the first sheet 10 and the second sheet 20 such that the first sheet 10 and the second sheet 20 are connected to one another through the connecting layer 35. The third melting point MP3 is less than the melting points MP1 and MP2.

The connecting layer 35 makes substantially full contact with the front face 15 of the first sheet 10 and the front face 25 of the second sheet 20 such that there are no gaps between the sheet 10 and the connecting layer 35 and between sheet 20 and connecting layer 35. This feature is very beneficial when the panel 40 is exposed to humidity or moisture that could accumulate in any gaps and promote the growth of bacteria such as mildew.

The connecting layer 35 may be a thermoplastic such as polypropylene or polyolefin. Additionally, the connecting layer 35 may be a co-polymer such as a modified polyolefin. A key distinction between the material for the connecting layer 35 and the thermoplastic within the first sheet 10 and the second sheet 20 is that the connecting layer 35 is a thermoplastic-compatible material that will melt at a lower temperature than the thermoplastic within the first sheet 10 and within the second sheet 20.

The first sheet 10 and the second sheet 20 may be identical materials or, depending upon the application, may be different materials in as much as the connecting material 35 is capable of bonding to the thermoplastics within these materials.

The first sheet 10 and the second sheet 20 may have identical thicknesses; however; depending upon the application for the panel, the thicknesses of each sheet may be different. Furthermore, as a general guideline, the thickness T1 (FIG. 2) of the first sheet 10 and the thickness T2 of the second sheet 20 are at least twice the thickness T3 of the connecting layer 35, although, as seen in FIG. 2, these proportions are exaggerated for clarity. In one embodiment, the thickness T1 of the first sheet 10 and the thickness T2 of the second sheet 20 are approximately 0.1 inch while the thickness T3 of the connecting layer 35 is approximately 0.05 inch.

In one application, the panel 40 may be used in refrigeration trucks such that the first sheet 10 acts as a wall while the second sheet 20 acts as a scuff pad.

Unlike the prior art, which utilized mechanical fasteners or glue to secure one sheet to another sheet, the subject invention utilizes a connecting layer. Directing attention to FIGS. 2 and 3, the connecting layer 35 (FIG. 2) is produced by depositing upon the front face 15 of the first sheet 10 a connecting film 45 and, furthermore, by depositing upon the front face 25 of the second sheet 20 a connecting film 50. The connecting film 45 and the connecting film 50 are heated and melted into a single connecting layer 35. These connecting films 45, 50, as illustrated in FIG. 4, are placed against one another and as indicated in FIG. 5, heat is applied to the exposed surfaces of the first sheet 10 and the second sheet 20 at a temperature above the melting point MP3 of the connecting films 45, 50, but below the melting points MP1, MP2 of the thermoplastic within the first sheet 10 and the second sheet 20. As a result, the connecting film 45 and the connecting film 50 melt together to form a single connecting layer 35 between the first sheet 10 and the second sheet 20 as shown in FIG. 6.

While typically identical materials would be used for the connecting film 45 and connecting film 50, it is possible for the connecting layers 45, 50 to be made of different materials as the circumstances warrant and have different melting points, but lower than the melting points of their respective sheets 10, 20.

What has so far been described is the melting of the carrier film 45 and carrier film 50 between the first sheet 10 and the second sheet 20 to form a connecting layer 35 between the first sheet 10 and the second sheet 20. However, for the connecting layer 35 to properly bond to the first sheet 10 and the second sheet 20, it is necessary to first secure each connecting film 45, 50 to its respective sheet 10, 20.

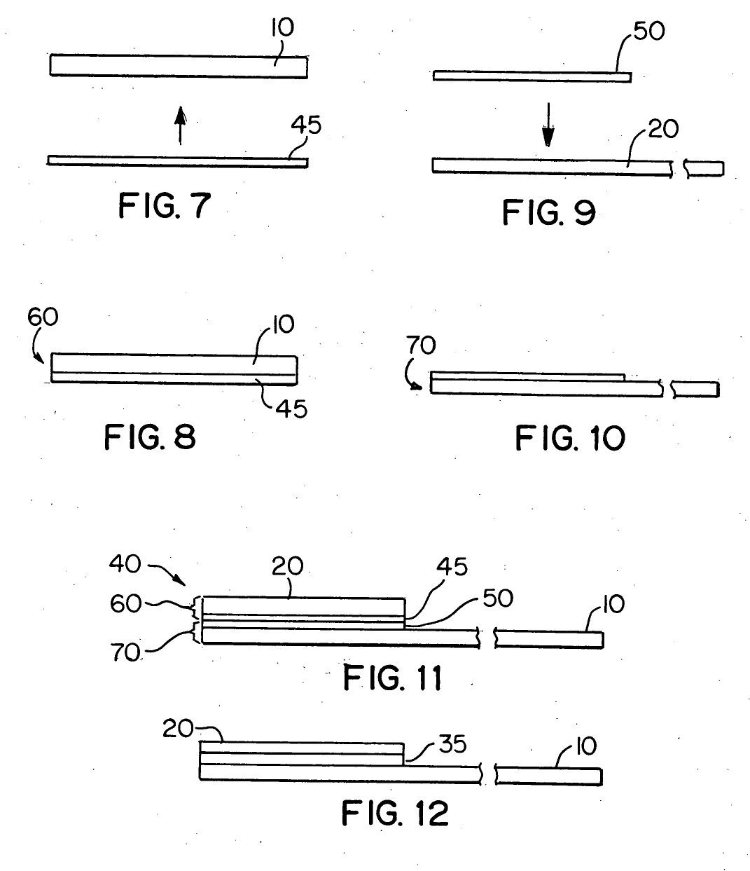

A method of forming a multi-layer fiber reinforced thermoplastic panel 40 is illustrated in FIGS. 7-12. In particular, fabrication of the panel 40 (FIG. 2) with the first fiber reinforced thermoplastic sheet 10 bonded to the second fiber reinforced thermoplastic sheet 20 will be described. The thermoplastic in the first sheet 10 has a first melting point MP1 and the thermoplastic in the second sheet 20 has a second melting point MP2.

Briefly stated, the connecting layers of each sheet must first be fused to each sheet by heating the connecting layer and the sheet to a temperature not only above the melting point of the connecting layer, but also above the melting point of the thermoplastic in the sheet. This is best performed at the time of fabrication of the sheet because heating the sheet to a temperature above the melting point of the thermoplastic in the sheet after the sheet is fabricated will cause the sheet to warp.

Furthermore, while the material of each connecting film typically will be identical and therefore each film will have the same melting point as the connecting layer, it is possible for each connecting layer to be a different material. Therefore, under these circumstances, the connecting films will have different melting points, but still have melting points less than the melting points of the thermoplastic within the sheets.

Directing attention to FIG. 7, a first connecting film 45 is introduced upon the first sheet 10, wherein the first connecting film 45 is made of a thermoplastic-compatible material having a third melting point MP3, which is less than the first melting point MP1, defining a first arrangement 60 as illustrated in FIG. 8. The first arrangement 60 is heated to a temperature above the first melting point MP1 of the first sheet 10, which is also above the melting point MP3 of the connecting film 45, to bond the first connecting film 45 to the first sheet 10. It is important to exceed the melting point MP1 of the first sheet to fully fuse the connecting film 45 thereto. The mating of the connecting film 45 with the first sheet 10 should occur at the time the first sheet 10 is fabricated, since after the first sheet has cooled from fabrication, subsequent heating above the melting point of the sheet will cause the sheet to warp.

Directing attention to FIG. 9, a second connecting film 50 is introduced upon the second sheet 20 to define a second arrangement 70 as illustrated in FIG. 10. The second connecting film 50 is made of a thermoplastic-compatible material having a third melting point MP3 which is less than the second melting point MP2. The second arrangement 70 is heated to a temperature above the second melting point MP2 and the third melting point MP3 to bond the second connecting film 50 to the second sheet 20. It is important to exceed the melting MP2 of the second sheet to fully fuse the connecting film 50 thereto. The mating of the connecting film 50 with the second sheet 20 should occur at the time the second sheet 20 is fabricated, since after the second sheet has cooled from fabrication, subsequent heating above the melting point of the sheet will cause the sheet to warp.

As illustrated in FIG. 11, the first arrangement 60 is placed against the second arrangement 70 such that the first connecting film 45 is contacting the second connecting film 50 to define a composite panel 40. The composite panel 40 is then heated to a temperature above the third melting point MP3 but below the first melting point MP1 and second melting point MP2 to bond the connecting films 45, 50 to one another to form a connecting layer 35 as illustrated in FIG. 12, and thereby bonding the first sheet 10 to second sheet 20 and forming the composite panel 40.

The method may be further comprised of compressing the first arrangement 60 against the second arrangement 70 to promote bonding of the connecting films 45, 50 to their respective sheets 10, 20. The step of compressing may occur during or after heating the first arrangement 60 and the second arrangement 70. Once the connecting films 45, 50 have been heated above their melting points and fused into a single connecting layer 35, the first arrangement 60 and the second arrangement 70 may be cooled in a controlled fashion utilizing any number of different technologies known in the art of thermoplastic fabrication.

Additionally, during or after heating the composite panel 40, the panel 40 may be compressed to promote adhesion of the connecting films 45, 50.

One preferred application of the sheet in accordance with the subject invention is as a wall of a refrigerated trailer. Briefly returning to FIG. 2, the first sheet 10 may extend seven feet high along the wall of a trailer while the second sheet 20 may extend a distance of approximately three feet from the edge of sheet 10 which is resting upon the floor of the trailer. In this manner, the second sheet 20 acts as a scuff plate to deflect impact or other movement of the contents within the trailer that would normally scuff or puncture the trailer walls. As a result, the shape of such a panel may generally be described as L-shaped.

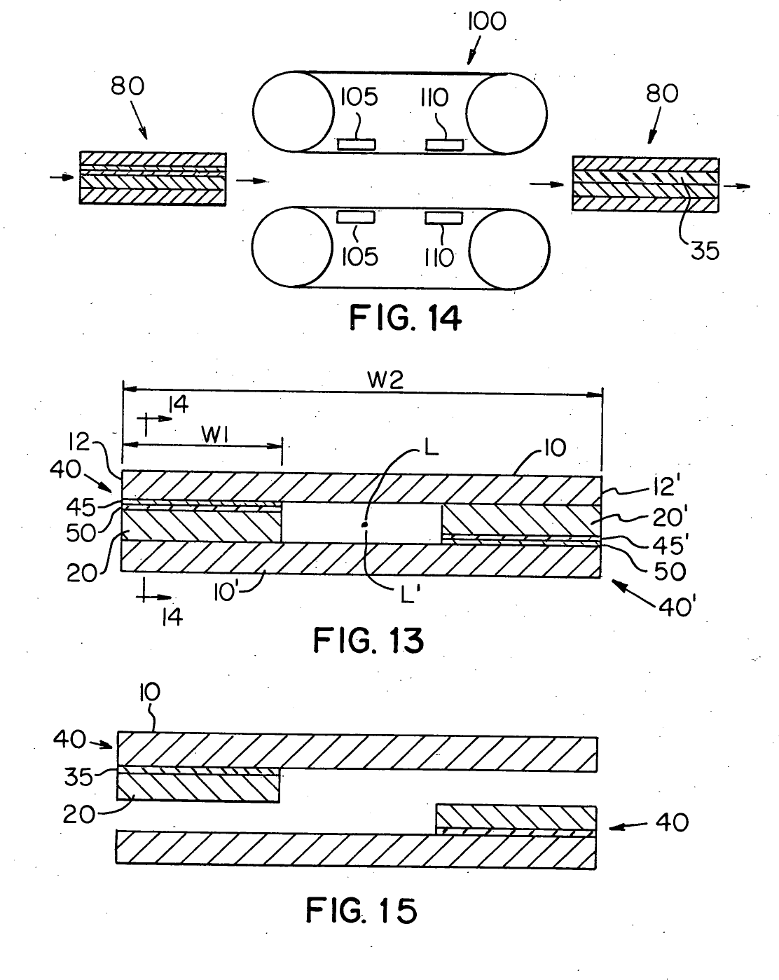

As a result, as illustrated in FIGS. 13-15, a pair of identical composite panels 40, 40′ may be made simultaneously. As illustrated in FIGS. 4 and 13, each panel 40 has a longitudinal axis L and is made of a first fiber reinforced thermoplastic sheet 10 and a second fiber reinforced thermoplastic sheet 20 with connecting film 45, 50 therebetween and bonded to each sheet 10, 20. The second sheet 20 has a width W1 which is less than half that of the width W2 of the first sheet 10. The second sheet 20 is positioned at one edge 12 of the first sheet 10. An identical composite panel 40′, wherein identical reference items are indicated with a prime sign, is placed against the composite panel 40 such that the second sheet 20, 20′ of each panel 40, 40′ contacts the first sheet 10, 10′ of the other panel 40, 40′ to form a symmetrical shape when viewed along the longitudinal axis L. The arrangement of the pair of panels 40, 40′ illustrated in FIG. 13 is also illustrated in FIG. 14 and identified as reference number 80. It should be noted that this arrangement in FIG. 14 is viewed from the side as shown by arrows 14-14 in FIG. 13. Oriented in this fashion, the second sheets 20, 20′ (FIG. 13) provide vertical support to the first sheets 10, 10′ such that this arrangement 80 may be acted upon a double belt press 100 to assist in bonding each first layer with each second layer.

Directing attention to FIG. 14, the arrangement 80 when introduced within the double belt press 110 is compressed. The double belt press 100 also contains heaters 105 which act upon the arrangement 80 and raise the temperature of the connecting films 45, 50 above their melting point MP3 but below the melting points MP1, MP2 of the thermoplastic within the first sheet 10 and the second sheet 20 such that the connecting layer 35 is formed. Once the connecting layer 35 is formed, it is desirable to cool the connecting layer 35 and coolers 110 are provided downstream of the heaters 105 to accomplish this task. The double belt press 100 along with the heaters 105 and coolers 110 used therein are commercially available products. Once the arrangement 80 is passed through the double belt press 100, the connecting layer 35 is formed, thereby bonding the first sheet 10 to the second sheet 20 on each of the panels 40, 40′, such that, as illustrated in FIG. 15, the panels may be separated and the respective first sheet 10 and the second sheet 20 are bonded through the connecting layer 35.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

The invention claimed is:

1. A multi-layer fiber reinforced thermoplastic panel comprised of:
a) a first fiber reinforced thermoplastic sheet, wherein the thermoplastic has a first melting point;
b) a second fiber reinforced thermoplastic sheet, wherein the thermoplastic has a second melting point; and
c) a connecting layer between the first sheet and the second sheet,wherein the connecting layer is made of a thermoplastic-compatible material having a third melting point less than the first and second melting points and wherein the connecting layer is bonded to the thermoplastic in the first sheet and in the second sheet.

2. The panel according to claim 1, wherein the connecting layer makes substantially full contact between the first sheet and the second sheet such that there are no gaps between the sheets and the connecting layer.

3. The panel according to claim 1, wherein the connecting layer is polypropylene.

4. The panel according to claim 1, wherein the connecting layer is polyolefin.

5. The panel according to claim 1, wherein each of the first sheet and second sheet are identical materials.

6. The panel according to claim 1, wherein each of the first sheet and the second sheet has an identical thickness.

7. The panel according to claim 1, wherein the thickness of each of the first sheet and the second sheet is at least twice the thickness of the connecting layer.

8. The panel according to claim 7, wherein the thickness of each of the first sheet and the second sheet is approximately 0.1 inch, while the thickness of the connecting layer is approximately 0.05 inch.

9. The panel according to claim 1, wherein the first sheet is a wall and the second sheet is a scuff pad.

10. The panel according to claim 9, wherein the first sheet is a wall and the second sheet is an integral scuff pad used as a wall for a trailer.

11. A method of forming a multi-layer fiber reinforced thermoplastic panel with a first fiber reinforced thermoplastic sheet bonded to a second fiber reinforced thermoplastic sheet, wherein the thermoplastic in the first sheet has a first melting point and the thermoplastic in the second sheet has a second melting point, comprising the steps of:
a) introducing a first connecting film upon the first sheet, wherein the first connecting film is made of a thermoplastic-compatible material having a third melting point, which is less than the first melting point, to define a first arrangement;
b) heating the first arrangement to a temperature above the first melting point to bond the first connecting film to the first sheet;
c) introducing a second connecting film upon the second sheet, wherein the second connecting film is made of a thermoplastic-compatible material having a fourth melting point less than the second melting point to define a second arrangement;
d) heating the second arrangement to a temperature above the second melting point to bond the second connecting film to the second sheet;
e) placing the first arrangement against the second arrangement such that the first connecting film is contacting the second connecting film to define a composite panel;
f) heating the composite panel to a temperature above the third and fourth melting points but below the first and second melting points to bond the connecting films to one another to form a connecting layer and thereby bond the first sheet to the second sheet.

12. The method according to claim 11, further comprising during or after heating the first arrangement and the second arrangement, the step of compressing the first arrangement and the second arrangement to promote bonding of the connecting films to their respective sheets.

13. The method according to claim 12, further comprising after the step of heating the first arrangement and the second arrangement the step of cooling the first arrangement and the second arrangement.

14. The method according to claim 11, further comprising during or after heating the composite panel the step of compressing the composite panel to promote adhesion of the connecting films.

15. The method according to claim 14, further comprising after the step of heating the composite panel the step of cooling the composite arrangement.

16. A method of making a pair of identical composite panels, wherein each composite panel has a longitudinal axis and is made of a first fiber reinforced thermoplastic sheet with a second fiber reinforced thermoplastic sheet attached thereto by a connecting film bonded to each sheet, wherein the second sheet has a width less than half that of the first sheet and wherein the second sheet is positioned at the edge of the first sheet, wherein the method comprises the steps of:
a) placing one composite panel against the other composite panel such that the second sheet of each panel contacts the first sheet of the other panel to form a symmetrical shape when viewed along the longitudinal axis;
b) compressing the first sheet and second sheet against the connecting film; and
c) heating the pair of composite panels to a temperature above the melting point of the connecting film but below the melting point of the thermoplastic in each of the first and second thermoplastic sheets, such that the connecting film of each first and second sheet in each composite panel fuse to one another thereby forming a connecting layer and bonding together the first sheet and the second sheet of each composite panel.

17. The method according to claim 16, wherein the step of compressing is performed by a double belt press.

18. The method according to claim 16, wherein the step of heating is provided by heaters within the double belt press.

19. The method according to claim 16, further including after the step of heating the pair of composite panels the step of cooling the pair of composite panels.

20. The method according to claim 19, wherein the step of cooling is provided by coolers within the double belt press.

21. The method according to claim 16, wherein the thermoplastic-compatible material is thermoplastic.
